(19) United States
(12) Patent Application Publication
(10) Pub. No.: US 2002/0174106 A1
(43) Pub. Date: Nov. 21, 2002

(54) Method and apparatus for receiving information in response to a request

(75) Inventor: Frederic P. Martin, Richmond, VT (US)

Correspondence Address: Judith A. Szepesi, BLAKELY, SOKOLOFF, TAYLOR & ZAFMAN LLP, Seventh Floor, 12400 Wilshire Boulevard, Los Angeles, CA, 90025-1026, US

(73) Assignee: Actioneer, Inc.

(21) Appl. No.: 09/733,584

(22) Filed: Dec. 7, 2000

Related U.S. Application Data
(63) Continuation-in-part of application No. 09/468,222, filed on Dec. 20, 1999.
Application No. 09/468,222 is a continuation of application No. 08/798,453, filed on Feb. 10, 1997, now Pat. No. 6,026,410.
(60) Provisional application No. 60/169,539, filed on Dec. 7, 1999.

(51) Int. Cl. G06F 7/00

(52) U.S. Cl. 707/3

(57) ABSTRACT

An apparatus and method for processing a request is described. The method comprises receiving an input text expression from a user on a device, and parsing the input text expression to identify a keyword. The method further comprises determining a connector based on the keyword, and filling in a template in the connector, based on the input text expression. The method further comprises launching an agent identified by the connector based on the template, to perform predetermined tasks.

### RELATED APPLICATIONS

This application claims the benefit of U.S. Provisional Patent Application Serial No. 60/169,539, filed Dec. 7, 1999. This application claims the benefit of U.S. patent application Ser. No. 09/468,222, filed Dec. 20, 1999, which is a continuation application of U.S. Pat. No. 6,026,410, issued Feb. 15, 2000.

### FIELD OF THE INVENTION

The present invention relates to obtaining information, and more specifically, to obtaining information over a network based on keywords.

### BACKGROUND

Currently, handheld devices, such as systems based on the PalmOS and WinCE, are being used to obtain information from the Internet. However, most handheld devices have a small screen size, and limited memory. Additionally, users often have to pay per kilobyte of information sent to the handheld device. Therefore, directly accessing the Web from a handheld device is disadvantageous.

One prior art solution to this is to create a micro-browser, such as ProxyWeb and Palm PQA. The micro-browser reduces HTML, for display on the smaller devices, without requiring modification of the HTML.

However, the user has to enter a lot of information into the system, such as the address of the site (URL), a request for information from the site, etc. Furthermore, the user often has to navigate multiple pages to obtain the information he or she wishes. This is cumbersome, and also may be costly, depending on the per kilobyte cost of access.

One prior art solution is to use AvantGo, or a similar program. AvantGo requires a remote processing of HTML pages, using a remote server, or desktop software. Then, the prior art software reformats the HTML into new meta language document that is then rendered in a mini browser on the handheld. AvantGo accesses web content through synchronization with another computer that is connected to the network. Thus, a direct connection between a desktop machine with an Internet connection is used to obtain information. Therefore, a AvantGo does not provide remote access to the Internet.

Another prior art solution is ProxyWeb. Proxy web also requires remote processing of HTML pages, using a server. ProxyWeb reformats the HTML into a new meta language document, that is rendered on the handheld. ProxyWeb accesses the Internet through an IP connection to a dedicated proxy server. This is disadvantageous because it requires the maintenance of a proxy server.

### SUMMARY OF THE INVENTION

An apparatus and method for processing a request is described. The method comprises receiving an input text expression from a user on a device, and parsing the input text expression to identify a keyword. The method further comprises determining a connector based on the keyword, and filling in a template in the connector, based on the input text expression. The method further comprises launching an agent identified by the connector based on the template, to perform predetermined tasks.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a network on which the present invention may be implemented.

FIG. 2 is a block diagram of one embodiment of a computer system on which the present invention may be used.

FIG. 3A is a block diagram of the client and server systems.

FIG. 3B is a block diagram of one embodiment of a client connectivity system for the present invention.

FIGS. 4A-4B are a flowchart of one embodiment of the process.

FIG. 5 is an exemplary diagram of a connection document.

FIGS. 6-7 are illustrations of a request and a result being displayed.

### DETAILED DESCRIPTION

A method and apparatus for obtaining information is described. The present invention includes a device including a user input device for permitting a user to enter an input text expression, including a request for information to be obtained remotely. For one embodiment, the device is a handheld device. For another embodiment, the device may be a desktop system, or any other type of device that can obtain connectivity to a network, and present data to a user. The handheld device includes a connection document defining keywords to detect a request, and other clipping and connection information. The handheld device further includes a parsing device for identifying keyword(s), key phrases, or grammatical expressions in the input text expression. Based on the keyword and data identified by the parsing device, a query to an address is formatted based on the identified keyword. The handheld device then transmits the query to the address. The response is generally received as streaming HTML. The handheld device extracts the relevant information from the HTML data on-the-fly, and displays the relevant information, appropriately formatted on the handheld device. The handheld devices accesses target servers directly through an IP connection—there is nothing between the handheld and the server.

The technology to support these services consists of thin client applications running on all types of computing platforms, including wireless handheld devices, and agents running on the client platform or on a server.

The set of potential services is virtually unlimited. Agents are independent autonomous software programs that can run on the user's client platform, on a dedicated server, on any other server, or on any combination of the above. Agents can have their own user interface, request services from other agents, or spawn other agents to run concurrently. Once the client has parsed the user request and dispatched the agent with its connector information and the user's data, the agent is on its own and does whatever it needs to do to complete the request. The information that the agent needs is composed of a data template contained in a “connector” file and the data that the user supplies. The system binds the user supplied data to the template and passes it to the agent. The agent examines the data and decides whether it can proceed. If the data is incomplete or is questionable then the agent can put up its own UI and request help from the user. If the data is complete, the agent can continues to complete its mission.

In the following description, numerous specific details are set forth in order to provide a thorough understanding of the present invention. However, it will be apparent to one of ordinary skill in the art that these specific details need not be used to practice the present invention. In other circumstances, well-known structures, circuits, and interfaces have not been shown in detail in order to not obscure unnecessarily the present invention.

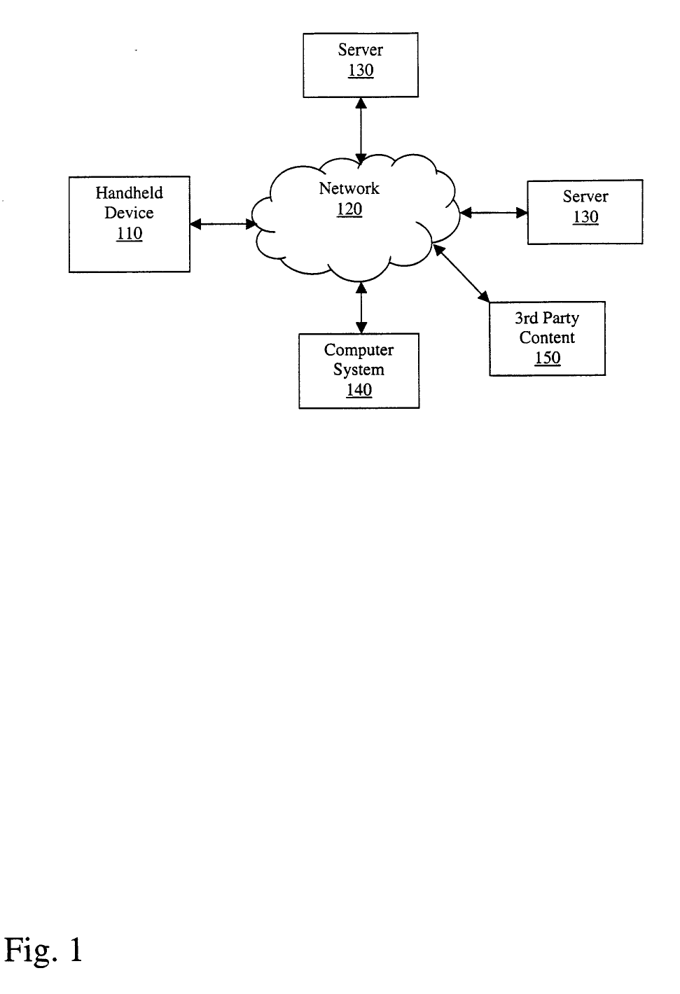

FIG. 1 is a block diagram of a network on which the present invention may be implemented. The handheld device 110 may be used to access the computer 140 or servers 130 through a network 120. The client 110 may access the network 120 through a wireless connection, modem, a digital subscriber line (DSL), a local area network (LAN), a wide area network (WAN), serial bus, or through other means. The network 120 may be an internal large area network (LAN), wide area network (WAN), the Internet, or another network. For one embodiment, if the client 110 accesses the computer 140, the network 120 may be eliminated, and a direct connection may be established between the client 110 and the computer 140.

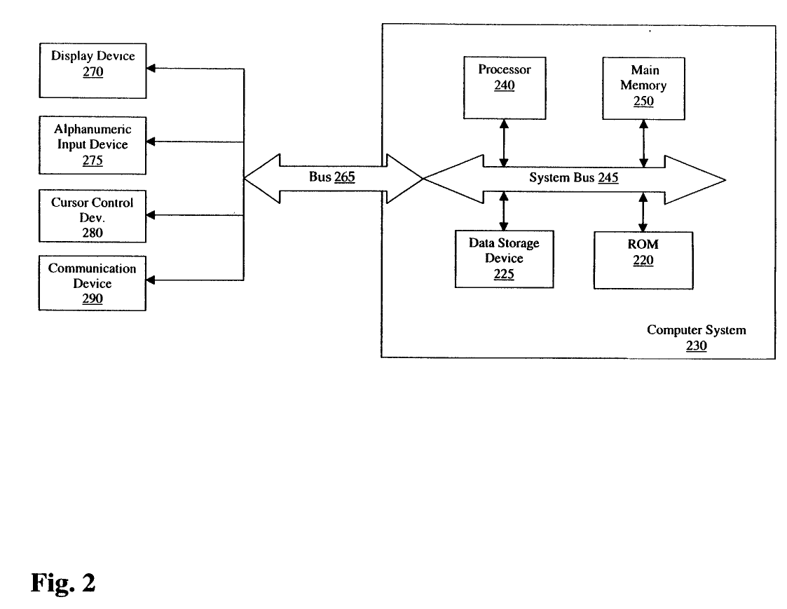

FIG. 2 is a block diagram of one embodiment of a computer system on which the present invention may be used. It will be apparent to those of ordinary skill in the art, however that other alternative systems of various system architectures may also be used.

The data processing system illustrated in FIG. 2 includes a bus or other internal communication means 245 for communicating information, and a processor 240 coupled to the bus 245 for processing information. The system further comprises a random access memory (RAM) or other volatile storage device 250 (referred to as memory), coupled to bus 245 for storing information and instructions to be executed by processor 240. Main memory 250 also may be used for storing temporary variables or other intermediate information during execution of instructions by processor 240. The system also comprises a read only memory (ROM) and/or static storage device 220 coupled to bus 240 for storing static information and instructions for processor 240, and a data storage device 225 such as a magnetic disk or optical disk and its corresponding disk drive. Data storage device 225 is coupled to bus 245 for storing information and instructions.

The system may further be coupled to a display device 270, such as a cathode ray tube (CRT) or a liquid crystal display (LCD) coupled to bus 245 through bus 265 for displaying information to a computer user. An alphanumeric input device 275, including alphanumeric and other keys, may also be coupled to bus 245 through bus 265 for communicating information and command selections to processor 240. An additional user input device is cursor control device 280, such as a mouse, a trackball, stylus, or cursor direction keys coupled to bus 245 through bus 265 for communicating direction information and command selections to processor 240, and for controlling cursor movement on display device 270. Furthermore, the system may include speech recognition software, and a microphone or other means of acquiring audio data.

Another device, which may optionally be coupled to computer system 230, is a communication device 290 for accessing other nodes of a distributed system via a network. The communication device 290 may include any of a number of commercially available networking peripheral devices such as those used for coupling to an Ethernet, token ring, Internet, or wide area network, or wireless standards such as BlueTooth or IEEE 802.11. Note that any or all of the components of this system illustrated in FIG. 2 and associated hardware may be used in various embodiments of the present invention.

It will be appreciated by those of ordinary skill in the art that any configuration of the system may be used for various purposes according to the particular implementation. The control logic or software implementing the present invention can be stored in main memory 250, mass storage device 225, or other storage medium locally or remotely accessible to processor 240. Other storage media may include floppy disks, memory cards, flash memory, or CD-ROM drives.

It will be apparent to those of ordinary skill in the art that the methods and processes described herein can be implemented as software stored in main memory 250 or read only memory 220 and executed by processor 240. This control logic or software may also be resident on an article of manufacture comprising a computer readable medium having computer readable program code embodied therein and being readable by the mass storage device 225 and for causing the processor 240 to operate in accordance with the methods and teachings herein.

The software of the present invention may also be embodied in a handheld or portable device containing a subset of the computer hardware components described above. For example, the handheld device may be configured to contain only the bus 245, the processor 240, and memory 250 and/or 225. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

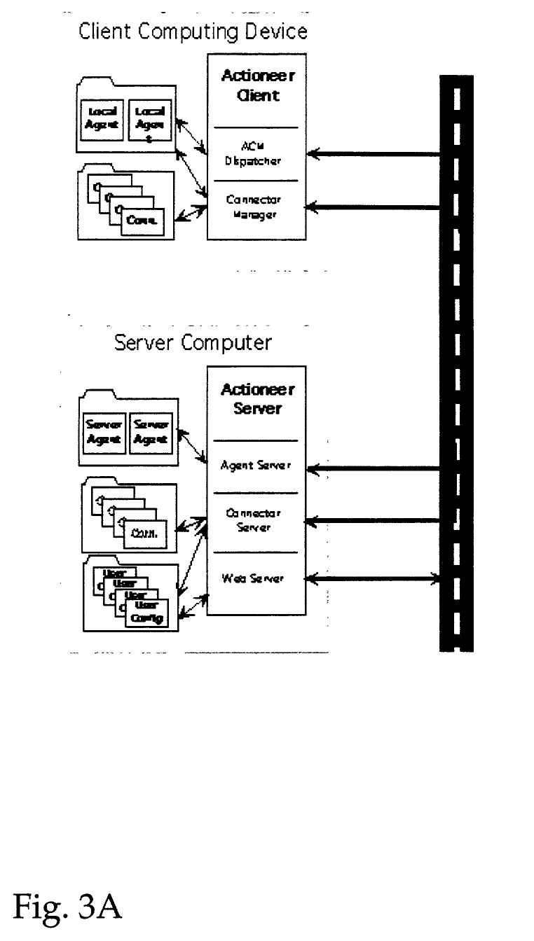

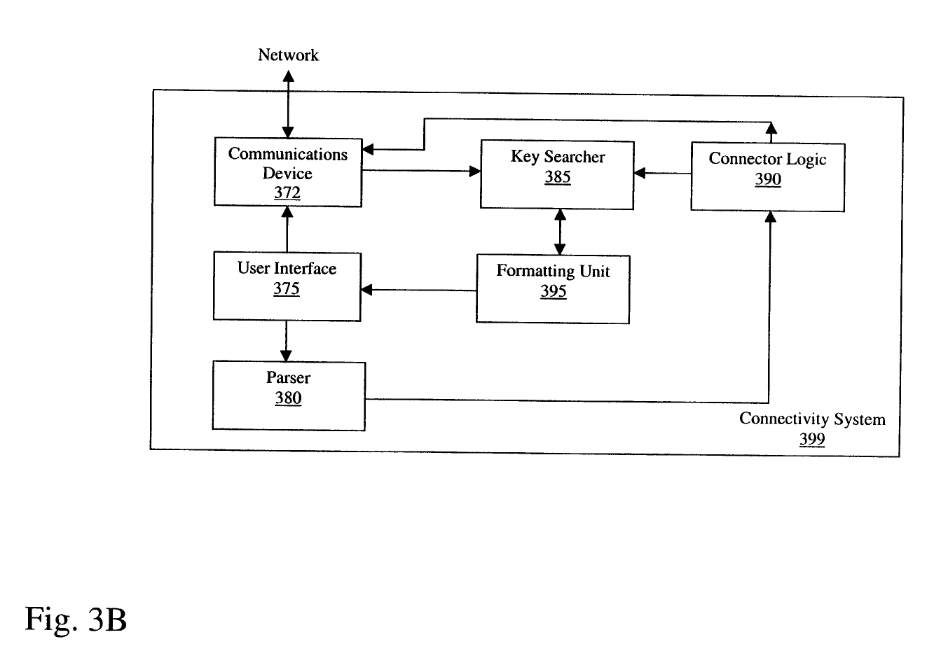

FIG. 3A is a block diagram of the client and server systems. Typically, a client device 110 includes client software 305, a set of default connectors 320, and a set of resident default agents 325. Client software 305 may or may not be enabled to access or use remote agents and/or connectors, depending on how the particular client software package is configured. The flexibility of packaging the different parts is a feature of the system. This allows us to create vertical market packages with customized agents and connectors for accessing proprietary or restricted services.

The server 130 consists of server software 330, connector archive 355, server based agents 360, and individual configuration files for each user 350. For one embodiment, the users manage their configuration files 350 via a conventional web browser. Each of these elements is described in more detail below.

As discussed above, the client software 305 includes four major parts—the console, the parser, the dispatcher 310, and the connector manager 315. The console, or user interface permits the user to interface with the client. The user may type, speak, write, or otherwise convey a request into the console. For one embodiment, the console provides visual feedback to give the user an idea of how it is interpreting the request. Thus, for example, recognized keywords may be underlined, linked-in data may be displayed, and similar actions may be taken. This permits a user to review immediately the current request, and edit it if necessary.

The parser is not a natural language parser. It performs keyword/phrase matching to parse words into known and fixed categories. FIG. 3B provides more detail on the parser.

The dispatcher 310, or Agent Command Message (ACM) dispatcher 310 is invoked when the user has entered a request. For one embodiment, the dispatcher 310 is invoked when the user commits to a request by, for example, clicking on the Send button. The dispatcher 310 then takes the results from the parser and binds the data in those results into the agent's data template. Thus, the agent does not receive the actual request entered by the user, but rather the keywords/phrases, and the data associated with the keywords/phrases obtained by the parser.

For one embodiment, the dispatcher 310 handles keyword/phrase stripping, filtering and translating as specified by the connector 320. It then invokes the agent and passes it the stripped and modified data as a message. For one embodiment, if the agent specified by the connector 320 is a server side agent, the dispatcher 310 sends the stripped, translated, and potentially modified data to the agent server 335 in the server 130. If the agent is a client side agent, the agent 325 responds to this message, as will be described in more detail below.

Agents, whether client-side or server-side, are independent and autonomous pieces of code. The system interface to an agent is defined completely by the data message which is passed to it by dispatcher 310. Connector files contain information that describes the agent's profile and contain information the agent needs. However, an agent has no knowledge of connectors, parsers, key phrases or any part of the system.

Agents can be developed, debugged and invoked completely independently of any other system components. An agent can be any size and can have a user interface or not. An agent can return data to the caller or not. Agents can be used to filter data, and be pipelined together. An agent can run on the client or on any server. A service provider can provide redundant services with agents providing the same service on a client platform or on a server. The client software 305 running on a PC might invoke an agent that completes a request on the PC whereas client software 305 running on a wireless handheld might invoke a server agent to handle the same request. Agents may call other agents, spawn other agents, queue messages for other agents or do anything else that makes sense in the context of satisfying a request from a user.

There are several types of agents designed for specific services. Some of the agents may include:

1) WebActions—a general purpose web access agent that obtains data from the World Wide Web. For one embodiment, WebActions may use a browser for result display.

2) Outlook—an agent that can capture appointments, notes, and more in Outlook. Similar agents may be built for all personal information management (PIM), email, or similar tools.

3) Palm Desktop—an agent that captures DateBook, Memo, and ToDo items and more. Similar agents may be built for other handheld devices, or PIMs.

As discussed above, agents can either reside on a client or a server. Agents, because they are executable, are platform specific. Therefore, client-side agents may include separate agents for MacOS, Windows, PalmOS, etc. Similarly, server-side agents may include separate agents for server platforms such as Windows NT, Apache, IIS, etc.

The agent provides a response that contains success or failure and may contain result data. The format of this message/response pair is the Agent Command Message (ACM). For one embodiment, the ACM may be written in XML and contain ActiveX. In short, the ACM may be in any format that permits an agent to perform potentially complex actions.

The connector manager 315 is responsible for installing the keywords and parsing rules from the connectors 320, initializing the agents 325, and doing automatic updating of connector files from their originating server. The connector manager also updates the local agents from the server in the same fashion that it updates connector files. This is done as transparently as possible to the user. The user generally has control over enabling/disabling of specific connectors defining new personal keywords, and selecting sets of connectors to use via the server connector catalog using a browser. This management process is described in more detail below.

The server 130 includes server software 330. Server software 330 includes agent server 335, which receives data from ACM dispatcher 310 in client 110, for server side agents. Agent server 335 then invokes the appropriate server-side agent 360, to perform the action(s) indicated by the data. For another embodiment, agents may access the agent server 335, to launch server-side agents.

Connector server 340 permits users to download connectors, and permits others to upload connectors. Connectors provide the glue that connects the user's request to the agent that processes it. Connectors consist of one or more files that are available to the client application and the agent associated with it. The information in the connector files identify the request category, the agent, the agent' data template, user hints, and anything else that is necessary to support the parser, dispatcher and agent. Connectors are available to the user for download to the client system 110 through connector server 340.

Web server 345 is used by clients to manage their configuration files via a conventional web browser. Web server 345 may further permit the downloading of the client software 305. For one embodiment, web server 345 automatically updates the user's configuration file 350, based on data received from the user. Thus, if web server 345 and connector server 340 are on different systems, the user's configuration still remains up-to-date. Users can also add their personal keywords/phrases using web server 345, as will be described in more detail below.

FIG. 3B is a block diagram of one embodiment of a client connectivity system 399 for the present invention. The communications device 372 permits the client to send messages to other devices. For one embodiment, if the client is a handheld device, communications device 372 may be a wireless modem or similar device. Other systems, such as BlueTooth, radio frequency, or other communications methods may be implemented by communications device 372.

Communications device couples the client to a network, through which the client can reach a server, or other devices.

The client further includes a user interface 375. The user interface 375 permits a user to enter shortcut grammar, or terse language commands. These commands are then passed to the parser 380.

Parser 380 recognizes the keywords, key phrases, and grammatical expressions in the data entered by the user. For one embodiment, parser 380 may be the parser described in U.S. Pat. No. 6,026,410, which is incorporated herein by reference. Alternative implementations of a parser may also be used.

The parser 380 performs keyword/phrase matching to parse words into known and fixed categories. Parser 380 has, for example, a fixed list of phrases that map directly to action categories such as “to do”, “calendar”, “note” or “web action.” For one embodiment, there are keyword/phrase dictionaries for tasks, dates, times, and e-services on the Web. For one embodiment, there may be keyword/phrase dictionaries for other things such as contact names and places.

The parser has a set of rules which enable parser 380 to make intelligent guesses about what may be a time or date and when a time or date may be invoking a calendar entry versus a task entry. For example, the phrase “call Bob today” may be entered as task whereas “lunch with Bob at 1:00 pm” may be entered as an appointment.

In addition, the parser can get help from a connector that may directly specify how the specific connector prefers the user to enter the data for that connector. For example, the “find person” web action can tell the parser 380 that the connector associated with that web action would prefer that user enter “find person first name mi, last name, address, etc.”

The parser 380 uses this template provided by the connector to try to parse the user's words into the proper place in the template. As soon as the parser 380 has figured out the action category and mapped the action category to a connector, the connector can give this template information to the console which can expose the preference data to the user to provide feedback, and/or to guide the user in completing the request.

For one embodiment, keywords/phrases are stored in lookup tables by category. For one embodiment, the categories are generic. such as tasks, calendar, notes, e-services, contacts, places, etc. Each entry in a category may map to multiple keywords/phrases. For one embodiment, these keywords/phrases are editable by the user. The parser 380 searches the keyword/phrase tables selectively depending on the context of the user request.

The parser 380 first tries to figure out the request category that is either a task, calendar, note or one of many possible e-services. The request category maps directly to appropriate connector for that request. For one embodiment, there is one, and only one, connector associated with each request category. The connector provides the rest of the context for the request. For example, a connector for the “find person” request would specify that parser should look for a contact name following the “find person” request. The parser would then begin searching the contacts keyword/phrase table.

If parser 380 got a hit parser 380 shows the format specified by the connector to the user, and inserts the contact's full name into the connectors data template. This template is then filled in with the rest of the contact information by the dispatcher 310, or is passed to the agent to handle. The user can, at this point, easily correct missed matches.

The parser then passes the keywords, key phrases, and grammatical expressions extracted from the user's entry to the connector file logic 390. Connector logic 390 includes certain actions associated with each of the keywords that may be used. The connector logic 390 pulls the appropriate connectors, and passes them to communications device 372. Communications device 372 performs the actions indicated by the connectors. For example, the connector may indicate that the communications logic 372 should access a certain web site, and retrieve some information. Communications logic accesses this web site, and retrieves the data. The incoming data is then passed to key searcher 385.

Key searcher 385 searches for the keys in the data returned by the agent. The keys associated with the particular agent/connector are indicated by the connector. For example, the in looking up the stock price of a company, the key may be “Latest price.” As explained in more detail below, the key searcher 385 extracts this information, and passes it to the formatting unit 395. Formatting unit 395 formats the relevant data, and passes it to user interface 375, for display. In this way, only the relevant data requested by the user is displayed, and in a format which is easily understood by the user. For one embodiment, formatting unit 395 is device specific. That is, each type of device, or each type of screen display, has an associated formatting unit, which formats the data presented to the user into a format that is most easily recognized and most usefully displayed, for the specific screen display.

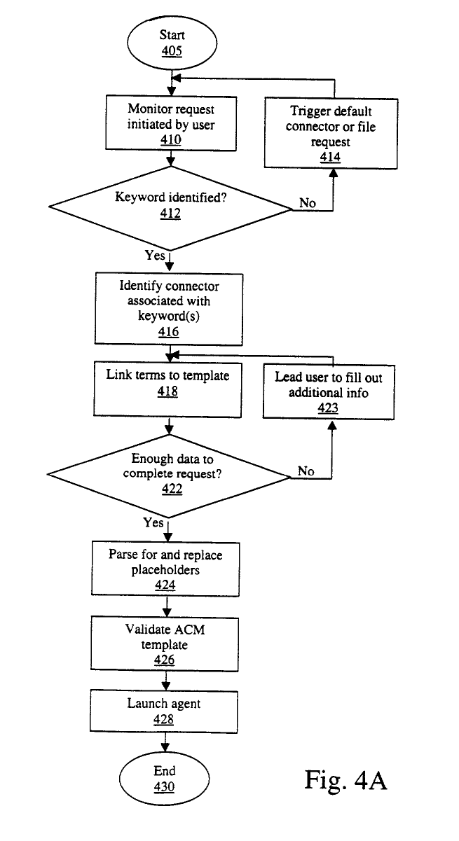

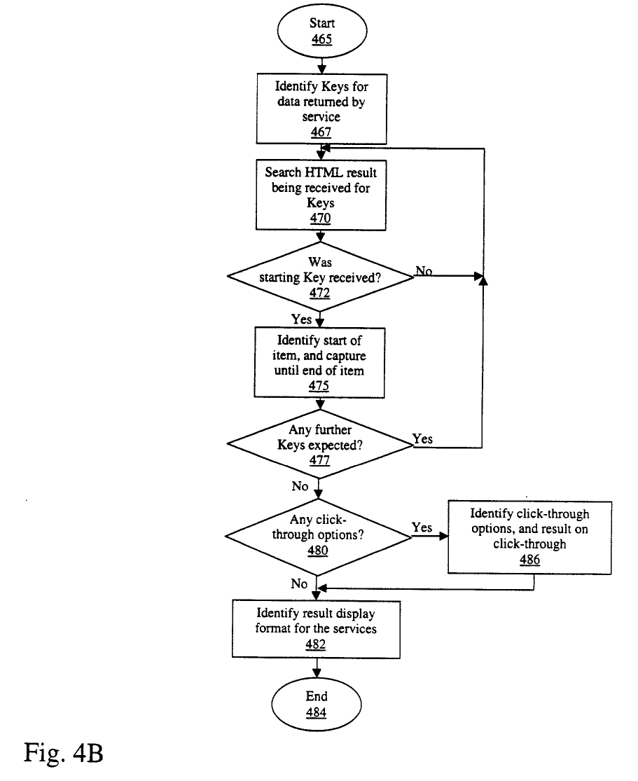

FIGS. 4A-4B are a flowchart of one embodiment of the process. FIG. 4A is a flowchart of sending a request and starting an agent. The process starts at block 405. For one embodiment, the process starts when the client software is accessed by the user, in readiness for entering a request. For another embodiment, the system may monitor the user's data input in a notepad or similar data entry mechanism. In that instance, the process starts when a request is initiated.

At block 410, a request is started by the user. The request is an abbreviated request, easily entered by the user. For one embodiment, the request may be entered in any form, typed, written, drawn (optical character recognition may be used), spoken (speech recognition software may be used), etc. Such entry of data into a client device is known in the art. The data entered by the user should include least one keyword/phrase, indicating the action(s) the user wishes to take. For simplicity, in the remainder of this description, the term keyword will be used. However, it is to be understood that the term “keyword” may refer to a word, a plurality of words, a phrase, or a grammatical construct.

At block 412, the process determines whether a keyword has been identified in the request. If no keyword has been identified, the process continues to block 414. At block 414, either the default connector is triggered, if one is set, or the request is filed. This permits the user to correct the request. The default connector may be specified by the user, or by the system. For example, the default connector may be to link all available information into the note, and place the note in the To Do list on the user's system. The process then returns to block 410.

If the keyword was recognized, at block 416, the connector associated with the keyword is identified. When a user inputs text into the client system, the client looks for keywords, key phrases, word order, and other language “cues” to select a connector or connectors that match that information. For one embodiment, the parser attempts to identify a connector at the earliest possible time, as data is being entered. The connector is associated with an agent and has a “template” of information required by the agent to execute its task. For one embodiment, as soon as the connector is identified, the template is displayed to the user, permitting the user to either enter data directly into the template, or be aware how his or her data entry is being converted into the template. For example, if the user enters “email Tom re mtg. on Tues.,” the connector may be identified when the user completes entering the term “email.” At this point, the connector is brought up. The connector indicates that additional data is required in the destination (to whom shall the email be sent), subject (what should the email be about), and content (what should be the text of the email).

At block 418, as the user enters various keywords, additional terms are linked to the template.

A connector includes a template, which may include some specific actions/text, and placeholder tokens, for data to be added by the user. Placeholder tokens are the vehicle by which user input and “real time” data and context are transferred from a client to an agent. For one embodiment, placeholder tokens also determine when a connector is selected.

Placeholder tokens are specially flagged text that are replaced by the dispatcher in a client software prior to the dispatcher sending an Agent Command Message (ACM) to an agent. For one embodiment, placeholder names begin with either a “$#” or “$!” or “$?” and end with a “$;” sequence. Alternative sequences may be used. However, the symbols used should not be parsed by the language being used to implement the agent, and thus should not invalidate it. For example, the symbols $, #, !, and ? are not parsed as XML and so will not invalidate an XML document. For one embodiment, the placeholder tokens accepted by the system are defined in a header file named “Tokens.h”.

For one embodiment, there may be three different start flags. The three different start flags correspond to how a placeholder is used:

“$#” Means this placeholder is required and must be filled with valid data by the client.

“$?” Means this placeholder is optional and may be filled by a client or agent if it has appropriate valid data available

“$!” Means that this placeholder is a required “passthrough” token. It is not to be filled by the client, instead, it is passed through to the agent (or agents) and will be filled in by them.

One place where a placeholder tokens is used is in an element called “ConnectRules.” This element contains “matchSet” elements. MatchSet elements generally have one or more placeholder tokens in them. These matchSet elements determine when a connector is selected based on input from the client. For example, if the connector has “$#Keyword$;” in a matchset element, then when a user types or selects any keyword from the connector's keyword set, your connector will be selected.

The second place a placeholder fields is used is in the Agent elements. If today's date is needed by an agent sent to an Agent, then a placeholder field such as “$#DTStampACM$;” is placed in the appropriate element. Clients that support this element will replace it with the appropriate data before sending it off to the agent.

Thus, in the above example, as the user enters the term “Tom” the system recognizes this is as keyword associated with a particular person in the user's address book. Therefore, the system looks up the data associated with the keyword Bob, and enters into the template the e-mail address associated with that keyword. In this case, for example, the email may be “thagan@actioneer.com.” This data is entered into the template. Then, the term re is recognized as a keyword indicating that the data following this keyword is the subject of the email. Therefore, the term “Meeting on Tuesday” would be selected as the subject of the email, for one embodiment. The system further parses the data, to recognize the Tuesday referred to. This type of parsing is described in the parent application of this case.

On further parsing, the system would look at the user's date book, and determine whether there was an entry regarding a meeting. For one embodiment, if an entry is found, any data associated with that entry would be entered into the body of the email. So, for example, if the user's date book included the data “Meeting about White Paper,” the text of the email may be: “Tom, this is a reminder that we have a meeting scheduled on Tuesday, Nov. 28, 2000, regarding the White Paper.” For one embodiment, an alternative connector may be invoked if there is no entry in the users date book. In that case, the email may read: “Tom, can you meet with me on Tuesday, Nov. 28, 2000? I am free between 2 and 5 p.m.” This data, again, is detected in the user's date book, and parsed into the template.

At block 420, when the user submits the request, the process identifies which determines whether all of the data has been entered into the template to complete the request. In the above example, the necessary items are the addressee, and a subject. If more information is needed, the system leads the user to fill in the additional data, at block 423, and the process returns to block 418, to analyze the user's further data entry/correction.

For one embodiment, user feedback indicating incomplete information is accomplished by a combination of visual and/or audible cues. For one embodiment, the feedback is of a completion nature—for example, the system makes positive sounds and highlights icons as more and more information is complete. For example, in a color system, the system may change the color of completed items to green, while required items that are not yet filled in are shown in red. Alternative visual cues may be used. The visual and audible cues “prompt” the user or “lead” the user to providing complete info. Thus the feedback at this point is prompting and verification. The prompting and verification information is provided by the connector file and possibly in partnership with the agent.

If sufficient data has been entered, the process continues to block 424. At block 424, the ACM template is parsed for “placeholder” tokens. The placeholder tokens are replaced with their associated data. Placeholder tokens may include run time data such as current date, current time, client id, user input arguments, categories, etc. This data is characterized as anything that would logically need to be chosen by a client (as opposed to static reference data). The client includes all potential placeholder tokens and has routines that can supply the correct replacement data.

At block 426, the now completed ACM template is validated. This verifies, that given the data provided by the user, the service will be rendered successfully. This is done before invoking the agent. This means that the client determines that the ACM is appropriate for the agent specified, that the computing environment can successfully launch the agent, and that all the placeholder tokens are replaced with valid data.

At block 428, the agent is launched. For one embodiment, the agent is launched after the user hits the “execute” button that launches the agent.

The ACM is sent. The client at this point responds only to fatal execution errors (launch failure, bad or incomplete ACM, timeout, etc). Once the request is made, any service related responses or errors are the responsibility of the agent. If the agent needs a user interface for this, then the agent may create it. For one embodiment, the agent may include a verification mechanism. The agent may present an error message saying that the action cannot be completed. At that point, the agent may solicit the additional required information or give the user the option to cancel.

Once an ACM has been accepted by an agent, the client software's job is done and it may go away. It should be noted here that the agent may be a server based agent, in which case, launching the agent may involve connecting with the server and sending the ACM via network protocol (this can also be accomplished through a local “stub” agent that acts as a conduit to the remote agent).

FIG. 4B is a flowchart of one embodiment of extracting the data to be displayed from the response. For one embodiment, this process is performed by an Agent that is configured to return data. As discussed above, this data may be obtained by the Agent from any source, including from the Web. The process starts at block 465. For one embodiment, this process is initiated when results are received in response to a request. For one embodiment, results may be received from an external or internal site or database.

At block 467, the keys are identified for the data returned by the service. The Keys are the terms which are recognized in a response. For example, in a response in HTML format, the meta-tag <table may be a start key, while the meta-tag </table>may be the end key. Generally, keys come in pairs. For one embodiment, within the data itself, keys may be recognized. For example, the symbol “$” or “£” or “¥” followed by numbers, or succeeding numbers, may be recognized as representing the cost of an item. Keys are associated with the particular data being retrieved from a particular site. Thus, the system knows the Keys associated with the data from the particular serve that was accessed.

At block 470, the data returned by the service is searched for the Keys. As noted above, the presence of the keys is known by the system. For one embodiment, Keys are identified in the connector as Starting Keys for all of, or a portion of the results. For example, if the requested result is a table, the starting key may be the meta-tag <table. For a price request for a particular book, the starting key may be the cost indication starting key, or the title starting key, depending on the site in question. For one embodiment, not each Starting Key has an associated Ending Key. For example, for a price, the only Key may be the symbol or word identifying the currency. In that instance, the format of the data itself may determine the data to be captured. Thus, for example, for a Key such as currency, the digits adjacent to the Key may be captured.

At block 472, the process determines whether the starting Key was received. If the starting key was not received, the process returns to block 470, and continues to scan to see whether there are any Keys in the HTML data being received. If a starting key is received, the process continues to block 475.

At block 475, the item associated with the starting key is identified, and the data is captured. For one embodiment, the data is captured until the associated ending key is found. For another embodiment, as described above, the actual data to be captured is associated with the Key. The data associated with the particular starting key is captured at this point. For one embodiment, this data is temporarily stored. For another embodiment, this data is reformatted on the fly. Reformatting data involves altering the data to be displayed in the format associated with the user's system. Thus, the data may be differently displayed on a handheld, a laptop, a portable telephone, or a pager. For one embodiment, the data output is optimized for the known factors of the display.

At block 477, the process determines whether there are any further starting keys identified in the connector for the service from which data is being received. If there are further keys—indicating that additional data needs to be captured—the process returns to block 470. Otherwise, the process continues to block 480.

At block 480, the process determines whether there are any click-through options. For one embodiment, for certain sites, there may be multiple pages that must be navigated to obtain the actual data. For one embodiment, for example, data may be inserted into the initial page, and the results may be retrieved from a subsequent page. If there are pages to be navigated, as determined by the Agent, the pages are navigated, in block 486.

At block 482, the result is identified, in its compact format. In accordance with the Agent specification, this result may now be displayed to the user, may be stored on the client system, may be sent to a third party, or may otherwise be disposed of, as appropriate. The agent then terminates, having successfully completed its task. The process then ends at block 484.

For one embodiment, the identification process is performed on streaming data. In other words, this search process, identified in blocks 470-477 is performed as data is being received from the service being accessed. This permits the server to avoid storing or displaying the full result before the requested data is obtained. Thus, for example if data is retrieved from a third party web site, if the page takes a long-time to load, the data may be extracted well before the page is completely loaded. In that case, the server can stop loading the page, and continue with the next task. This is advantageous since it speeds up response to user request, and frees up the server, to perform other processes. For another embodiment, the process may be performed after all of the data has been obtained from the service. In that instance, block 472, 475, and 477 may be eliminated, and block 470 may be modified to “identify each key or key pair, and capture associated data.” This may be simpler, if processing power is limited.

The process described above with respect to FIGS. 4A-B permits a user to enter a request including at least one keyword/phrase, and receive a prompt response from the service or services associated with the keyword/key phrase.

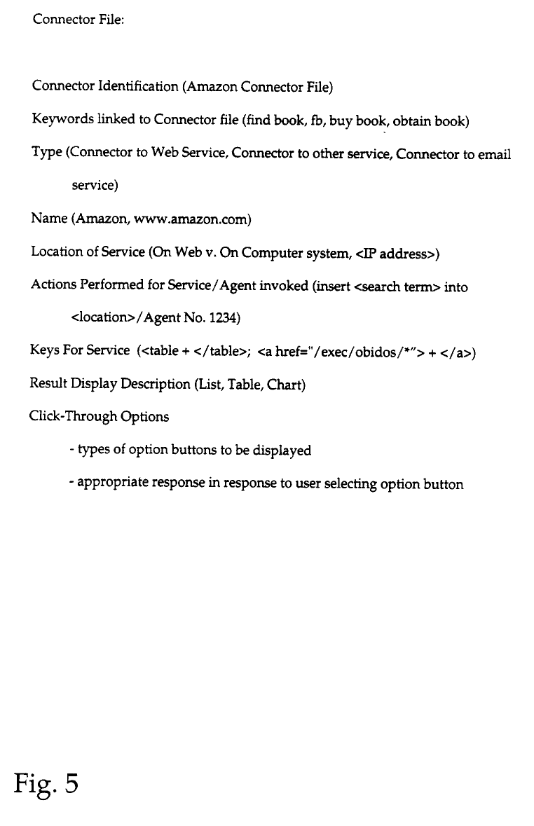

FIG. 5 is an exemplary diagram of a connection document. Note that although the terms “file” and “document” are used, connectors may be in any format. They may be independent files in ASCII or another form, they may be database entries, or they may be in some other format. Any format which can be recognized by the communications device may be used.

Generally, there is only one connector file per service. For one embodiment, the connector file may be a database entry. Alternatively, the connector file may be an independent file. There are several sections to a connector file.

For one embodiment, the connector file includes a type, name, and location of service. (service could be a file on your hard disk, could be a web server).

The connector file further may include keywords, key phrases, or grammatical expressions for the service. The parser uses the keywords to link to the service and determine what subpart of the service (if any) is to be used. For example the keywords “Find Book” links to connectors that have “Find Book” in their set of keywords, and flags on the keyword indicate that the text following the keywords is the text to be used to search for a book. The grammatical rules are actually contained in the connector—keywords are the primary arguments of a grammatical rule. For example, a common rule expressed literally is “presence of a connector keyword constitutes a link to this connector.” A rule that doesn't demand a keyword, for example, may be “presence of a date and a time constitutes a link to this connector”.

The connector file further includes the Actions to be performed. The actions identified by the connector file may be multiple steps. For one embodiment, the system can execute scripts. For one embodiment, instead of actually listing actions, the identity of an Agent is included in this portion. The Agent determines the actions that are performed, in response to this connector being invoked.

The connector file further includes Keys for results. The software watches for these keys in the stream of data coming from the service. There are Keys for “start of results”, “end of results”, “start of result item”, “end of result item”, etc. There may be other keys as well for example “Start of price of item”/“end of price of item”. Keys come in pairs. A typical key for start of results might be the string “<table” which is a partial HTML meta tag for the start of a table. The corresponding end tag would most likely be “</table>” in this case.

The connector file further includes a Result display description. This is the part that describes how the results from 2c are to be displayed. It does not necessarily correspond to HTML formatting, but rather, how the results are best displayed on the small device screen. For example—a Yahoo.com stock quote has results that are formatted in an HTML table for a big screen. The system watches for that table (using tags as described above) and pulls out result items. However, displaying them in a table on the handheld device is generally not optimal, because of the limited amount of space. Therefore, the Result display description may indicate that the information should be displayed in a list. The connector specifies that each item pulled from the stream based on the keys in 2c should be displayed as consecutive items in a list.

As a result of this format of displaying, the process does not need to wait for the document to complete downloading. Rather, as soon as the next item is received, it can be displayed. This reduces the wait for results considerably.

The connector file may further include Click through options. In some cases, the results from 2c are the final step. For example, if the service is a dictionary lookup, the results are the text from a dictionary entry. However, if the service is a book store, the user may want to make a purchase, get more info, etc. This section identifies the option buttons that should be displayed—purchase for example—and what action should happen if that option is selected by the user. For example, for Amazon, a 1-click charge order may be sent to the server for example, in response to the selection.

The connector documents are analogous to “plug-ins” but differ in that they do not necessarily have code in them. For one embodiment, connector files may include Java or c++ DLL.

The connector documents are installed or updated in one of several ways

a) They are preinstalled with the software (the default connectors) These may be code resources or documents in a directory, or records in a database. The handheld has preinstalled connectors in both resources and database record entries.

b) They can be installed by the user (drag and drop on desktop software, conduits for handheld software).

c) They can be fetched by the software periodically (manually or automatically) from a central “catalog” server.

d) They can be updated by the software at a location specified in a connector. For example, a service could put in a connector a field that says “check this URL every three days for a newer connector”.

If there is a catalog server, the connectors may be produced by the catalog server in many ways. For one embodiment, the catalog server has files in a folder that it sends directly to the client software. For one embodiment, the files may be in XML, so that a single connector source file may produce several different versions of the same connector depending on which version of our client is requesting it. For example—if the Windows 3.0 desktop client requests a new version of a connector, the XML style-sheet will produce an XML document that has the expected fields for that version. If the handheld client asks for a new version, the style-sheet will produce a document with the sections used to describe the results display.

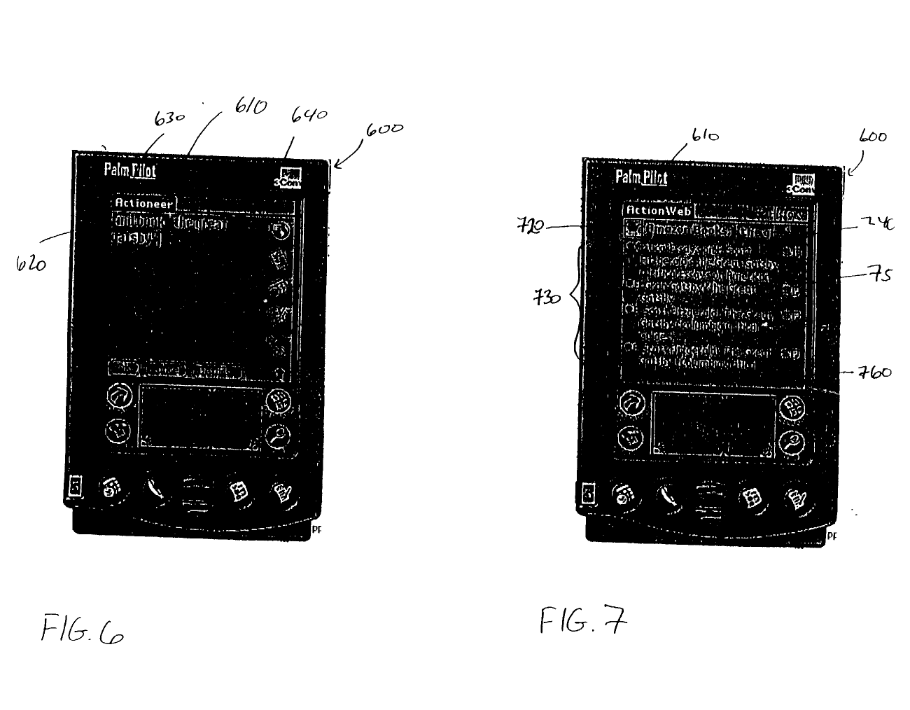

FIGS. 6-7 are illustrations of a request and a result being displayed.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving an input text expression from a user on a handheld device;
parsing the input text expression to identify a keyword;
determining a connector based on the keyword;
filling in a template in the connector, based on the input text expression; and
launching an agent identified by the connector based on the template, to perform predetermined tasks.

2. The method of claim 1, wherein the keyword includes multiple words in a key phrase.

3. The method of claim 1, wherein the connector includes grammatical rules.

4. The method of claim 1, wherein the metafile format is Hypertext Markup Language (HTML).

5. The method of claim 1, further comprising:
invoking a second agent to perform a plurality of actions on a remote system, to perform the query.
